(19) United States
(12) Patent Application Publication
(10) Pub. No.: US 2008/0022686 A1
(43) Pub. Date: Jan. 31, 2008

(54) Powertrain and method including HCCI engine

(75) Inventors: John K. Amdall, Washington, IL (US); Gerald N. Coleman, Helpston (GB); Kevin P. Duffy, Metamora, IL (US); David M. Milam, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/495,771

(22) Filed: Jul. 31, 2006

(51) Int. Cl. F02B 73/00; B60K 1/02; B60K 6/00; F02B 5/00

(52) U.S. Cl. 60/716; 180/65.2; 477/3

(57) ABSTRACT

A powertrain including an HCCI engine is disclosed. The HCCI engine is configured to supply mechanical power, and a generator operably coupled to the HCCI engine is configured to convert at least a portion of the mechanical power into one of electric energy and hydraulic energy. The powertrain further includes a motor operably coupled to the generator. The powertrain also includes an energy storage device operably coupled to the generator and the motor. The powertrain further includes a controller configured to control the powertrain such that energy stored in the energy storage device is supplied to the motor when the HCCI engine supplies insufficient mechanical power to the generator to supply the motor with sufficient power to meet power requirements of the powertrain, until the HCCI engine supplies sufficient mechanical power to the generator to supply the motor with sufficient power to meet the power requirements of the powertrain.

### TECHNICAL FIELD

This present disclosure relates generally to powertrains and methods of operating a powertrain including a homogeneous-charge compression ignition (HCCI) engine, and more particularly, to a vehicle and methods of operating a vehicle including a hybrid powertrain including an HCCI engine.

### BACKGROUND

Growing concern over the reduced availability and rising cost of oil has renewed interest in improving the efficiency of internal combustion engines. In addition, growing concern over preserving the environment has renewed interest in reducing the emissions of internal combustion engines, for example, to meet future government-mandated emission regulations. As a result, there is a desire to provide more efficient internal combustion engines and powertrains while reducing emissions.

Two conventional types of internal combustion engines are spark-ignition engines and compression-ignition engines. These two types of internal combustion engines provide inherent relative advantages and disadvantages. For example, spark-ignition engines tend to emit lower emissions than compression-ignition engines due at least in part to post-combustion emissions systems. On the other hand, compression-ignition engines tend to provide inherently higher thermal efficiency than spark-ignition engines. Thus, there may be a desire to provide an internal combustion engine that emits relatively low emissions while maintaining a relatively high thermal efficiency.

An internal combustion engine that operates according to a homogeneous-charge compression ignition mode (an HCCI engine) may provide a possible solution to the desire to provide an internal combustion engine that exhibits relatively lower emissions and relatively higher thermal efficiency. An HCCI engine operates in a manner similar to a compression-ignition engine. In a conventional compression-ignition engine, a relatively concentrated charge (i.e., having a relatively rich air-fuel mixture) located in a relatively small area within the engine's combustion chamber auto-ignites when compressed to a critical temperature. In an HCCI engine, a relatively dispersed air-fuel mixture (i.e., a relatively homogenous air-fuel mixture) auto-ignites within the combustion chamber when compressed to a critical temperature, which results in a reduction of emissions relative to a conventional compression-ignition engine while still maintaining a thermal efficiency similar to a conventional compression-ignition engine.

An HCCI engine, however, may suffer from a number of possible drawbacks. For example, it may be relatively difficult to control operation of an HCCI engine while still operating with a desired homogeneous air-fuel mixture. For example, it may be relatively difficult to control the ignition timing when the homogeneous air-fuel mixture is introduced into the combustion chamber. Moreover, it may be relatively difficult to control an HCCI engine such that it is able to respond quickly to desired changes in engine load and/or engine speed. Thus, although an HCCI engine may provide a desirable combination of reduced emissions and increased thermal efficiency, it may difficult to use an HCCI engine in applications that are likely to result in quickly changing loads and/or engine speeds.

An example of a vehicle including a hybrid vehicle driving system is described in U.S. Pat. No. 6,570,265 (“the '265 patent”) issued to Shiraishi et al. on May 27, 2003. The '265 patent describes a hybrid vehicle driving system including an engine, which is controlled such that the engine operates on a lean mixture for the longest possible part of the total operating time of the engine.

Although the hybrid vehicle driving system of the '265 patent may permit the engine to operate more efficiently, the '265 patent's hybrid vehicle driving system is unable to operate its engine in an HCCI mode substantially independent of the load and/or vehicle speed requirements placed on the powertrain. Thus, the '265 patent's hybrid vehicle driving system does not operate its engine consistently in an HCCI mode.

The disclosed exemplary powertrains and methods may be directed to overcoming one or more of the desires set forth above.

### SUMMARY OF THE DISCLOSURE

In one aspect, the present disclosure includes a powertrain. The powertrain includes an HCCI engine configured to supply mechanical power and a generator operably coupled to the HCCI engine. The generator is configured to convert at least a portion of the mechanical power into one of electric energy and hydraulic energy. The powertrain further includes a motor operably coupled to the generator. The motor is configured to supply torque to a propulsion member. The powertrain also includes an energy storage device operably coupled to the generator and the motor. The energy storage device is configured to store one of electric energy and hydraulic energy. The powertrain further includes a controller operably coupled to the HCCI engine, the generator, the motor, and the energy storage device. The controller is configured to control the powertrain such that energy stored in the energy storage device is supplied to the motor when the HCCI engine supplies insufficient mechanical power to the generator to supply the motor with sufficient power to meet power requirements of the powertrain, until the HCCI engine supplies sufficient mechanical power to the generator to supply the motor with sufficient power to meet the power requirements of the powertrain.

According to another aspect, a vehicle includes a powertrain including an HCCI engine configured to supply mechanical power. The powertrain further includes a generator operably coupled to the HCCI engine. The generator is configured to convert at least a portion of the mechanical power into one of electric energy and hydraulic energy. The powertrain also includes a motor operably coupled to the generator. The motor is configured to supply torque to a propulsion member. The powertrain further includes an energy storage device operably coupled to the generator and the motor. The energy storage device is configured to store one of electric energy and hydraulic energy. The powertrain also includes a controller operably coupled to the HCCI engine, the generator, the motor, and the energy storage device. The powertrain further includes a propulsion member configured to propel the vehicle. The controller is configured to control the powertrain such that energy stored in the energy storage device is supplied to the motor when the HCCI engine supplies insufficient mechanical power to the generator to supply the motor with sufficient power to meet power requirements of the powertrain, until the HCCI engine supplies sufficient mechanical power to the generator to supply the motor with sufficient power to meet the power requirements of the powertrain.

According to yet another aspect, a method for operating a powertrain including an HCCI engine includes generating mechanical power via operation of the HCCI engine and converting at least a portion of the mechanical power into one of electric energy and hydraulic energy. The method further includes supplying the energy to a motor and an energy storage device and driving a propulsion member via the motor. The method also includes controlling the powertrain such that energy stored in the energy storage device is supplied to the motor when the HCCI engine generates insufficient mechanical power to supply the motor with sufficient power to meet power requirements of the powertrain, until the HCCI engine supplies sufficient mechanical power to supply the motor with sufficient power to meet the power requirements of the powertrain.

### BRIEF DESCRIPTION OF THE DRAWINGS

FIG. 1 is a schematic block diagram of a vehicle including a hybrid powertrain according to an exemplary disclosed embodiment.

FIG. 2 is a schematic, partial section view of an internal combustion engine according to an exemplary disclosed embodiment.

FIG. 3 is a schematic block diagram of an internal combustion engine according to an exemplary disclosed embodiment.

FIG. 4A is a schematic view of a fuel injector and fuel spray according to an exemplary disclosed embodiment.

FIG. 4B is a schematic view from line A-A of FIG. 4A.

FIG. 5 is a schematic block diagram of a vehicle including a hybrid powertrain according to an exemplary disclosed embodiment.

FIG. 6 is a schematic block diagram of a vehicle including a hybrid powertrain according to an exemplary disclosed embodiment.

FIG. 7 is a graph depicting relationships among power demanded, power output, and energy storage according to an exemplary disclosed embodiment.

### DETAILED DESCRIPTION

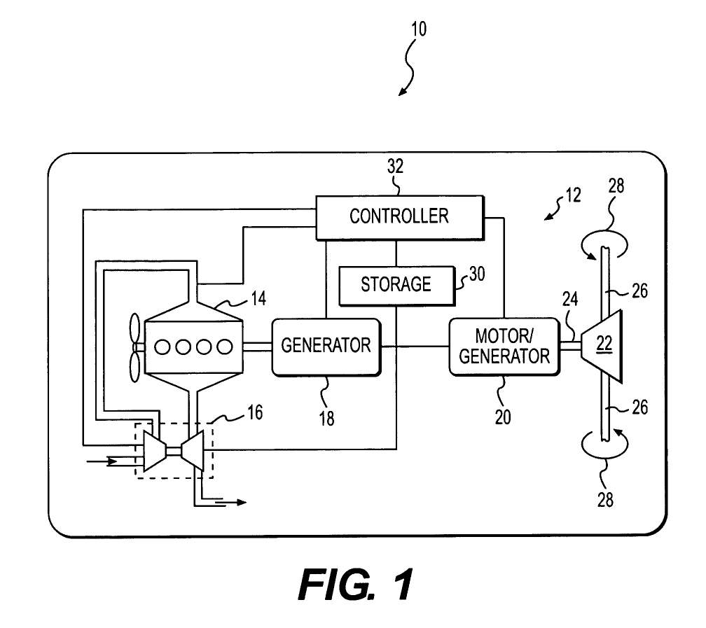

FIG. 1 illustrates an exemplary vehicle 10, including a powertrain 12 configured to provide power for operating systems of vehicle 10 and/or for propelling vehicle 10. Vehicle 10 may be, for example, an automobile, a truck, a rail vehicle, such as a train or a subway train, or a construction vehicle (e.g., such as a track-type tractor, a wheel loader, a hydraulic excavator, motor grader, or the like). Vehicle 10 is not necessarily limited to ground-borne vehicles. For example, vehicle 10 may be a water-borne vehicle, such as a boat or ship, or an airplane.

In the exemplary embodiment depicted in FIG. 1, powertrain 12 may include one or more internal combustion engines 14 configured to convert fuel into mechanical power. Internal combustion engine(s) 14 may include an air compression device 16, for example, one or more surpechargers or turbochargers. Internal combustion engine 14 may be operably coupled to one or more generators 18 configured to convert mechanical power into electric power or hydraulic power. Generator(s) 18 may be operably coupled to one or more motor/generator(s) 20 configured to convert electric power or hydraulic power into mechanical power and/or convert mechanical power into electric power or hydraulic power. For example, motor/generator(s) 20 may be an electric machine or a hydraulic motor/pump. Motor/generator(s) 20 may be operably coupled to a differential 22 via a drive member 24. Differential 22 may be configured to drive one or more output members 26, which may be operably coupled to one or more propulsion members 28, which serve to propel vehicle 10. Propulsion member(s) 28 may be, for example, drive wheels, tracks (i.e., tracks of a track-driven vehicle), and/or propellers (i.e., for a boat or an airplane).

As shown in FIG. 1, exemplary powertrain 12 may include one or more energy storage devices 30 operably coupled to generator 18, motor/generator 20, and/or internal combustion engine 14 (e.g., at air compression device 16), such that energy (i.e., electric energy or hydraulic energy) may be stored for later use by powertrain 12 and/or other systems of vehicle 10. Energy storage device(s) 30 may include, for example, any batteries and/or capacitors known to a person having ordinary skill in the art. According to some embodiments, powertrain 12 may be a hydraulic powertrain and energy storage device(s) 30 may include, for example, one or more accumulators for storing pressurized hydraulic fluid. Powertrain 12 may include a controller 32 configured to coordinate the operation the various components of powertrain 12, as will be explained in more detail herein.

According to some embodiments, air compression device 16 may include one or more turbochargers including an exhaust-driven turbine, which, in turn, drives a compressor operably coupled to the exhaust-driven turbine. The compressor may be configured to increase the mass of air supplied to internal combustion engine 14, thereby increasing the power output of internal combustion engine 14. If, however, the exhaust-driven turbine is driven by exhaust such that it provides power exceeding the amount of power required to meet the power demands of internal combustion engine 14, the excess power may be used to generate electric power or hydraulic power (e.g., via a generator operably associated with the exhaust-driven turbine), which may be stored in energy storage device 30. According to some embodiments, at least a portion of excess power supplied by the exhaust turbine may be diverted back to internal combustion engine 14 (e.g., via a gear train operably connected to a crankshaft of internal combustion engine 14), which is sometimes referred to as “turbo’ compounding.” According to some embodiments, air compression device 16 may include one or more superchargers. Such operation may be coordinated by controller 32.

According to some embodiments, motor/generator 20 may be used to generate electric power as well as provide mechanical power to differential 22. For example, if vehicle 10 is coasting (e.g., downhill) or the operator desires to slow the speed of vehicle 10, mechanical power provided by propulsion members 28 may be transferred through output members 26, differential 22, and drive member 24, to motor/generator 20. Motor/generator 20 may convert mechanical power into electric power or hydraulic power, which may be stored in energy storage device 30 for later use. Controller 32 may control such operation.

Internal combustion engine 14 may be any type of engine that includes at least one combustion chamber and may have one of many configurations known to those skilled in the art. For example, internal combustion engine 14 may have in-line, horizontally-opposed, V, H, or rotary architecture, and may include at least one cylinder configured to operate as a combustion chamber (e.g., 1, 2, 3, 4, 5, 6, 8, 10, 12, or 16 cylinders).

According to some embodiments, internal combustion engine 14 may operate as a homogeneous-charge compression ignition (HCCI) engine. An HCCI engine may operate in a manner similar to a conventional compression-ignition engine by virtue of an HCCI engine lacking a spark to initiate combustion. In particular, combustion in an HCCI engine begins when an air-fuel mixture in a combustion chamber reaches its auto-ignition temperature. An HCCI engine differs from a conventional compression-ignition engine by virtue of the fuel and air being distributed in a substantially homogeneous manner in the combustion chamber prior to combustion. In contrast, the mixture of air and fuel in a conventional compression-ignition engine is not necessarily mixed in a substantially homogeneous manner prior to combustion.

An HCCI engine may be relatively difficult to operate in such a manner that it responds quickly to changes in load and/or desired engine speed. This characteristic may render an HCCI engine at least somewhat less desirable for certain applications where it is desirable for the engine to respond quickly to changes in load and/or desired engine speed, for example, vehicle applications.

According to some exemplary embodiments of powertrain 12, for example, as depicted in FIG. 1, powertrain 12 may be configured to permit internal combustion engine 14 to be an HCCI engine while still being suitable for vehicle use. For example, as depicted in FIG. 1, internal combustion engine 14 supplies mechanical power to run generator 18. Generator 18 converts mechanical power into electric power or hydraulic power and supplies the electric or hydraulic power to motor/generator 20. Motor/generator 20 converts electric or hydraulic power from generator 18 into mechanical power to drive differential 22 via drive member 24. Differential 22 supplies rotational power to output members 26, which, in turn, drive propulsion members 28 to propel vehicle 10 according to operator commands. The operator may occupy vehicle 10 while making the commands, the operator may provide commands remote from vehicle 10, and/or operation of vehicle 10 may be pre-programmed.

Electric or hydraulic power generated by generator 18 that is not needed to respond to an operator's commands, may be stored in energy storage device 30, which may include one or more batteries and/or capacitors of types known to a person having ordinary skill in the art (i.e., when the energy stored is electric energy). Alternatively, excess hydraulic power may be stored in one or more accumulators, for example, when generator 18 is a hydraulic pump (e.g., a fixed displacement or variable displacement hydraulic pump).

According to some embodiments, for example, for vehicles 10 including work implements, such as wheel loaders, dozers, backhoe loaders, hydraulic excavators, and track-type loaders, excess energy of the work implements may be stored in energy storage device 30. For example, if a bucket of a wheel loader has been raised, the bucket has potential energy due to its raised position and gravity. As the bucket is lowered, the change in potential energy may be stored in energy storage device 30 (e.g., an accumulator).

Controller 32 may be operably connected to internal combustion engine 14, generator 18, motor/generator 20, and/or storage device 30, and may send and/or receive signals, such that operation of internal combustion engine 14, generator 18, motor/generator 20, and/or energy storage device 30 is coordinated in a manner such that vehicle 10 responds appropriately to an operator's commands.

According to some embodiments, powertrain 12 may be configured to operate internal combustion engine 14 at a relatively constant load and/or engine speed, for example, a load and/or engine speed that generally optimizes efficiency and/or emissions of internal combustion engine 14. For example, powertrain 12 may operate internal combustion engine 14 at, for example, at least about 25% of full load and between about idle speed and about 2,000 rpm (e.g., about 25-50% of full load and about 1,200 rpm). Propulsion and/or operation of vehicle 10's systems may be powered by electric power generated by generator 18, which is driven by internal combustion engine 14. For example, motor/generator 20 receives electric power from generator 18 and, in turn, supplies mechanical power to propulsion members 28 according to an operator's commands. If internal combustion engine 14 is providing more mechanical power to generator 18 than required to meet an operator's commands, excess power generated by generator 18 may be stored in energy storage device 30.

If energy storage device 30 has reached its full capacity of stored energy, generation of electric or hydraulic power via generator 18 may be reduced or ceased, for example, by reducing the speed and/or load of generator 18 and/or ceasing operation of generator 18. This may be accomplished by, for example, reducing the speed and/or load of internal combustion engine 14, stopping operation of internal combustion engine 14, and/or disconnecting internal combustion engine 14 from generator 18 (e.g., via a clutch). Such operation of powertrain 12 may be coordinated via controller 32.

If, on the other hand, more power is required than can be supplied by internal combustion engine 14 and generator 18 to propel vehicle 10 according to an operator's commands in a sufficiently responsive manner (e.g., due either to vehicle 10 traveling up a hill or an operator's desire to increase vehicle speed quickly), motor/generator 20 may receive additional electric or hydraulic power from energy storage device 30, such that vehicle 10 operates in a manner sufficiently responsive to the operator's commands, for example, until internal combustion engine 14 increases output sufficiently to meet operator's commands. Such operation of powertrain 12 may be coordinated via controller 32.

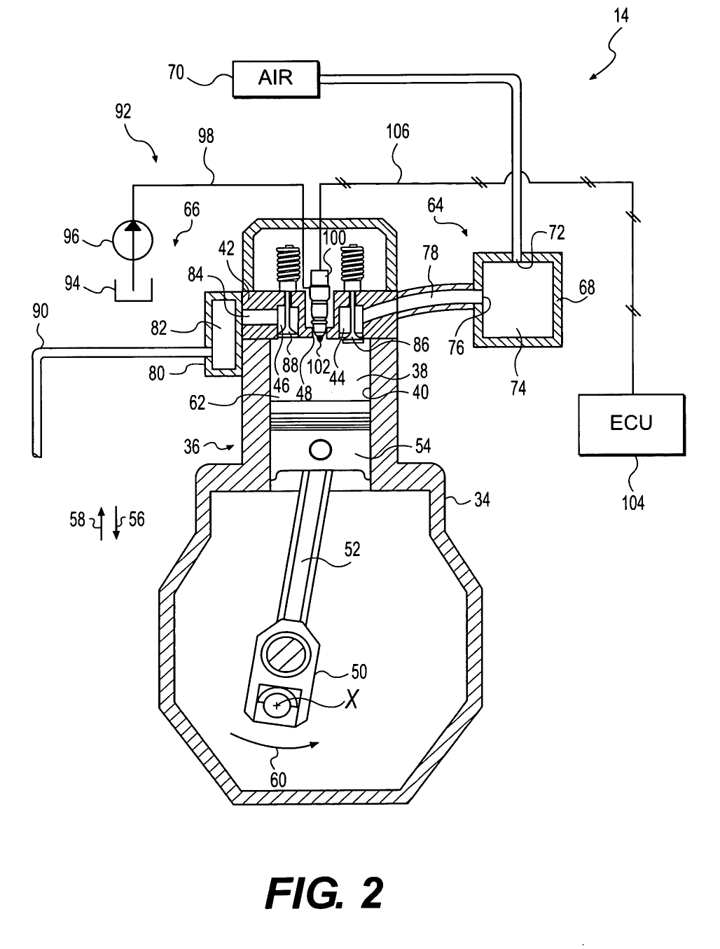

FIG. 2 schematically depicts an exemplary embodiment of internal combustion engine 14. According to some embodiments, internal combustion engine 14 may include a block 34 defining a cylinder assembly 36. Cylinder assembly 36 includes one or more cylinders 38 defined therein. Cylinder(s) 38 are defined by cylinder walls 40 in block 34. Exemplary internal combustion engine 14 includes a cylinder head 42 operably associated with block 34 (e.g., cylinder head 42 may be formed integrally with block 34 or operably coupled to block 34 in another manner (e.g., via fasteners and/or a gasket)). Cylinder head 42 includes one or more intake ports 44, one or more exhaust ports 46, and one or more fuel ports 48 defined therein.

Exemplary internal combustion engine 14 includes a crankshaft 50 configured to output mechanical energy from internal combustion engine 14 in the form of rotation of crankshaft 50. Crankshaft 50 is operably coupled to one or more connecting rods 52, such that connecting rod(s) 52 are coupled at a distance from the axis of rotation X of crankshaft 50. Each of connecting rod(s) 52 are operably coupled to a piston 54. Piston 54 is configured to reciprocate within an associated cylinder 38 in the general direction of arrows 56 and 58. As piston 54 moves downwardly in the general direction of arrow 56 to the position shown in FIG. 2, connecting rod 52 urges crankshaft 50 to rotate in the general direction of arrow 60 by virtue of connecting rod 52 being coupled a distance from the axis of rotation X of crankshaft 50. Subsequently, as crankshaft 50 continues to rotate in the general direction of arrow 60, crankshaft 50 urges connecting rod 52 and associated piston 54 in the general direction of arrow 58, such that piston 54 is returned to an uppermost position (i.e., the top dead center position) within associated cylinder 38.

Piston 52, cylinder wall 40, and cylinder head 42 cooperate so as to define a combustion chamber 62, which defines a volume that varies with the motion of piston 54. In particular, when piston 54 is advanced in the general direction of arrow 58, the volume of combustion chamber 62 is decreased. On the other hand, when piston 54 is advanced in the general direction of arrow 56, the volume of combustion chamber 62 is increased.

Exemplary internal combustion engine 14 includes an intake system 64 and an exhaust system 66. Intake system 64 includes a plenum member 68 and an air source 70. Plenum member 68 defines an inlet opening 72, a plenum chamber 74, and an exit opening 76. Air source 70 supplies air to inlet opening 72 and into plenum chamber 74. It is noted that the description pertaining to FIG. 2 refers to “air,” which refers to any suitable fluid medium that may be used, such as, for example, recirculated exhaust gas combined with air, and the like. Intake system 64 may include an intake conduit 78 in fluid communication with exit opening 76 of plenum member 68. Exhaust system 66 includes an exhaust chamber 80 defining an exhaust manifold 82 in fluid communication with exhaust port 46 via an exhaust passage 84 in cylinder head 42.

Exemplary internal combustion engine 14's cylinder head 42 is operably associated with one or more intake valves 86 and one or more exhaust valves 88 associated with each cylinder 38. Intake valve(s) 86 are configured to selectively place plenum chamber 74 in fluid communication with combustion chamber 62, and exhaust valve(s) 88 are configured to selectively place combustion chamber 62 in fluid communication with exhaust manifold 82.

In particular, intake valve 86 may be actuated in a known manner, such as, for example, via a camshaft, either directly or in combination with a pushrod and a rocker arm, driven by rotation of crankshaft 50. Alternatively, intake valve 86 may be actuated via, for example, hydraulic actuation, electronic actuation, a combination of electro-hydraulic actuation, and the like. When intake valve 86 is in an open position, (as shown in FIG. 2), air may be advanced from intake conduit 78 into combustion chamber 62 via intake port 44. Conversely, when intake valve 86 is in a closed position, air is prevented from advancing from intake conduit 78 into or out of combustion chamber 62 (i.e., via intake valve 86), since intake valve 86 blocks fluid flow through intake port 44.

Exhaust valve 88 may be actuated in a known manner, such as, for example, via a camshaft, either directly or in combination with a pushrod (not shown) and a rocker arm, driven by rotation of crankshaft 50. Alternatively, exhaust valve 88 may be actuated via, for example, hydraulic actuation, electronic actuation, a combination of electro-hydraulic actuation, and the like. When exhaust valve 88 is open, exhaust gases may be advanced from combustion chamber 62 to exhaust manifold 82 via a fluid path that includes exhaust port 46 and exhaust passage 84 in cylinder head 42. From exhaust manifold 82, exhaust gases are advanced to an exhaust conduit 90. When exhaust valve 88 is closed (as shown in FIG. 2), exhaust gases are prevented from advancing from combustion chamber 62 to exhaust manifold 82, since exhaust valve 88 blocks fluid flow through exhaust port 46.

According to some embodiments, internal combustion engine 14 may be configured to use one or more of any known fuels, such as, for example, gasoline, diesel fuel, ethanol, methanol, bio-diesel fuel, crude oil, lubricating oil, an emulsion of water and diesel fuel, or any combination thereof. Generally, the fuel may be any type of fuel that is at least somewhat resistant to auto-ignition, for example, a fuel that has a lower cetane number.

Exemplary internal combustion engine 14 includes a exemplary fuel system 92, including a fuel reservoir 94, a fuel pump 96, a fuel line 98, and a fuel injector 100. According to some embodiments, fuel injector 100 may be a cam-operated fuel injector. Fuel pump 96 is configured to draw fuel at low pressure from fuel reservoir 94 and advance the fuel under high pressure to fuel injector 100 via fuel line 98. Fuel injector 100 is located in fuel port 48 of cylinder head 42. Fuel injector 100 includes a fuel injector nozzle 102 and is configured to inject a quantity of fuel into combustion chamber 62 through fuel injector nozzle 102. For example, fuel injector 100 injects fuel into combustion chamber 62 upon receipt of an injector control signal from a controller 104 (e.g., a micro-processor based engine control unit (ECU)) via a signal line 106. Controller 104 may perform a variety of control functions related to operation of internal combustion engine 14, including, for example, controlling actuation of fuel injector 100. Controller 104 may be a physically separate unit or it may be incorporated into another controller, for example, it may be incorporated into powertrain controller 32 (see, e.g., FIGS. 1, 5, and 6).

The injector control signal may serve to control the timing and/or amount of fuel injected into combustion chamber 62. In particular, the amount of fuel injected via fuel injector 100 may serve to control the ratio of air to fuel (i.e., the “air-fuel” ratio) advanced to combustion chamber 62. For example, if a leaner mixture of air and fuel (i.e., a higher air-fuel ratio) is desired for combustion in combustion chamber 62, a fuel control signal received by fuel injector 100 via signal line 106 causes fuel injector 100 to operate such that less fuel is injected into combustion chamber 62. On the other hand, if a richer mixture of air and fuel (i.e., a lower air-fuel ratio) is desired for combustion in the combustion chamber 62, a fuel control signal received by fuel injector 100 via signal line 106 causes fuel injector 100 to operate such that more fuel is injected into combustion chamber 62. Other systems and/or methods for introducing fuel and air into combustion chamber 62 may be used without departing from the spirit and scope of the present disclosure. For example, fuel may be introduced to and/or mixed with air at any point between air source 70 and intake port 44, including upstream of air compression device 16.

Combustion of the air and fuel in combustion chamber 62 produces a number of exhaust gases, which flow out exhaust port 46, through exhaust passage 84, and into exhaust manifold 82. The exhaust gas may include, for example, oxides of nitrogen (NOₓ), hydrocarbons (HC), carbon monoxide (CO), smoke, and the like.

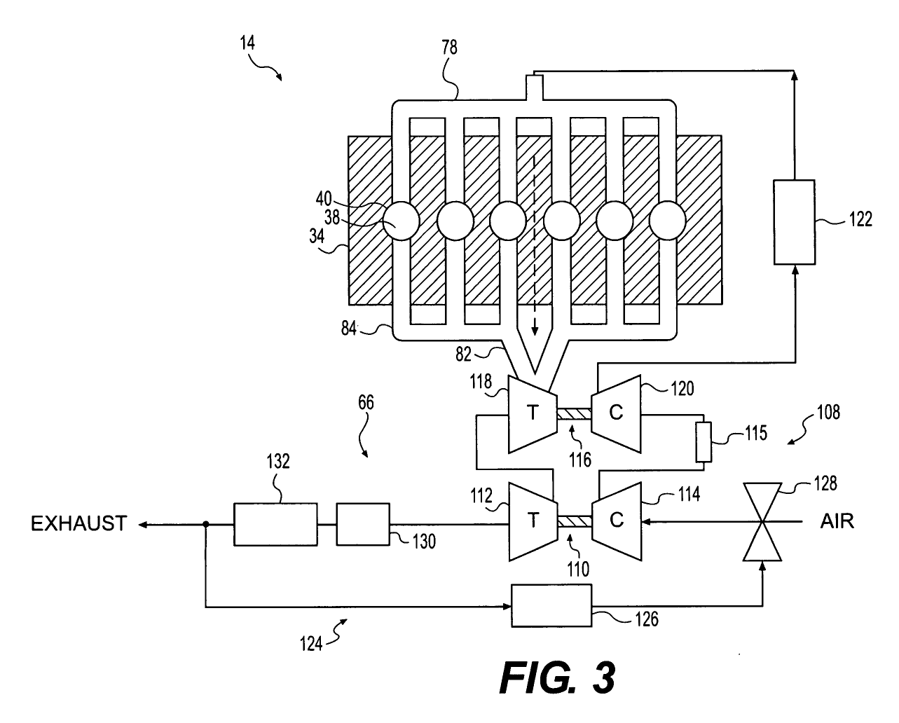

As schematically-depicted in FIG. 3, internal combustion engine 14 may include intake conduit 78 and exhaust passage 84, along with block 34, which provides a housing for at least one cylinder 38 defined by cylinder wall 40. Although FIG. 2 depicts six cylinders 38 and an in-line architecture, any number of cylinders 38 and/or architecture could be used, as outlined previously herein. Intake conduit 78 may be configured to provide an intake path to one or more of cylinders 38 for conveying air and/or recirculated exhaust gas to one or more of cylinders 38. Exhaust passage 84 may be configured to provide an exhaust path from one or more of cylinders 38 for exhaust gases.

Exemplary internal combustion engine 14 schematically-depicted in FIG. 3 includes an air compression device 16 in the form of a two-stage turbocharger system 108. Exemplary two-stage turbocharger system 108 includes a first turbocharger stage 110 having a low pressure turbine 112 and a first stage compressor 114. Two-stage turbocharger system 108 also includes a second turbocharger stage 116 having a high pressure turbine 118 and a second stage compressor 120. Some embodiments may include an intercooler 115 in flow communication between first stage compressor 114 and second stage compressor 120, for example, to increase the efficiency of two-stage turbocharger system 108. Internal combustion engine 14 may include an aftercooler 122 between air compression device 16 and plenum member 68. For example, as depicted in FIG. 3, aftercooler 122 is located between two-stage turbocharger system 108 and intake conduit 78. Aftercooler 122 is configured to cool the air entering intake conduit 78 to improve combustion.

Two-stage turbocharger system 108 may be configured to increase the pressure of air and recirculated exhaust gas being delivered to cylinders 38 via intake conduit 78, and/or to maintain a desired air-fuel ratio during an extended open duration of intake valve 86. Types of air compression devices other than exemplary two-stage turbocharger system 108 may be used. For example, internal combustion engine 14 may include a high pressure ratio single-stage turbocharger system, a variable geometry turbocharger system, or any other air compression system known to a person having ordinary skill in the art.

Exemplary internal combustion engine 14 depicted in FIG. 3 includes exhaust system 66, which includes an exhaust gas recirculation (EGR) system 124. Exemplary EGR system 124 is a low pressure loop EGR system. Types of EGR systems other than exemplary low pressure loop EGR system 124 may be used, such as, for example, by-pass systems, venturi systems, piston-pumped systems, peak clipping systems, back pressure systems, and/or any other EGR systems known to a person having ordinary skill in the art. For example, although an exemplary low pressure loop EGR system is depicted, a high pressure loop EGR system may be used. EGR system 124 may include an EGR cooler 126 and an EGR valve 128. EGR cooler 126 may be configured to cool a portion of the exhaust gases that are re-routed to intake system 64 when EGR valve 128 is opened. On the other hand, when EGR valve 128 is closed, exhaust gases are not re-routed to intake system 64.

Exhaust system 66 may include an oxidation catalyst 130 configured to receive exhaust gas from low pressure turbine 112. Oxidation catalyst 130 may be coupled with a NOₓ-reduction catalyst to reduce NOₓ emissions. Exhaust system 66 may include a particulate matter (PM) filter 132 configured to receive exhaust gas from oxidation catalyst 130 and remove particles from the exhaust gas. Although oxidation catalyst 130 and PM filter 132 are depicted as separate items, they may alternatively be combined into one assembly. Some or all of the exhaust gas may exit exhaust system 66 following exposure to PM filter 132. In some embodiments, a portion of the exhaust gas may be re-routed to, for example, intake conduit 78 via EGR system 124, as outlined above, and/or through two-stage turbocharger system 108.

According to some embodiments of EGR system 124 (not shown), a portion of the exhaust gas may be re-routed to intake conduit 78 from low pressure turbine 112 (i.e., prior to entering oxidation catalyst 130, as shown in FIG. 3), through an additional PM filter, then through EGR cooler 126, EGR valve 128, and two-stage turbocharger system 108. The additional PM filter may be smaller in size than PM filter 132 shown in FIG. 3, since only a portion of the exhaust gases are re-routed though two-stage turbocharger system 108. Moreover, installing the additional PM filter in the return path of the EGR system 124 may result in a more compact and manageable packaging and routing of the PM filter and the associated input and output ductwork in the vicinity of internal combustion engine 14.

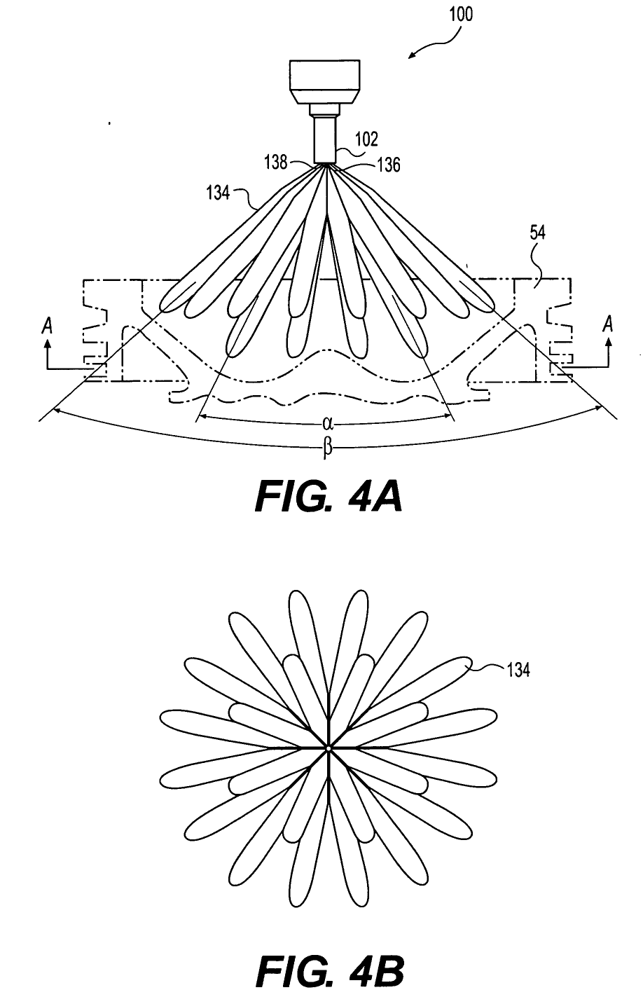

FIGS. 4A and 4B schematically-depict an exemplary fuel injector 100 and exemplary fuel spray 134. Exemplary fuel injector 100 includes fuel injector nozzle 102, which defines one or more injector nozzle openings 136. For example, exemplary fuel injector nozzle 102 depicted in FIG. 4A defines a plurality of micro-sized holes 138 (e.g., 10, 16, 24, 32, or any number of holes) arranged such that a desired fuel spray 134 is achieved. For example, exemplary injector nozzle opening(s) 136 shown in of FIGS. 4A and 4B are arranged to result in a 24-hole “showerhead” design. According to this exemplary arrangement, a first set of holes sprays fuel at a first dispersion angle α and a second set of holes sprays fuel at a second dispersion angle β. For example, a first set of eight holes sprays fuel at an angle α equal to about 50 degrees and a second set of sixteen holes sprays fuel at an angle β equal to about 90 degrees. Other numbers and arrangements of holes, sets of holes, and/or angles of dispersion may be used without deviating from the scope of the present disclosure.

Exemplary fuel injector nozzle 102 depicted in FIGS. 4A and 4B may result in fuel spray 134 that distributes fuel relatively uniformly throughout desired portions of combustion chamber 62 based at least partially on, for example, a particular geometry of piston 54. Such control of fuel spray 134's configuration may permit injection of fuel in advance of conventional injection timing and allow more time for fuel and air (i.e., fluid medium) to mix in a substantially homogeneous manner without a significant amount of fuel being allowed to deposit on cylinder wall 40 prior to combustion. In particular, it may be desirable for fuel spray 134 to be configured such that the fuel is dispersed substantially uniformly into combustion chamber 62 and is spaced from cylinder wall 40. For example, fuel spray 134 may be dispersed throughout combustion chamber 62 without any fuel contacting the cylinder wall 120, which may prevent fuel from being deposited in the lubricating oil on the cylinder wall 40. By virtue of cylinder wall 40 having a relatively lower temperature than the remainder of combustion chamber 62, fuel that contacts cylinder wall 62 may contribute to increasing the levels of HC and CO emitted as a result of combustion.

During exemplary operation of internal combustion engine 14 (e.g., an HCCI engine), fuel spray 134 may be directed downward toward piston 54, and injection of fuel into combustion chamber 62 may be timed to occur in advance of top dead center of piston 54's travel in the upward direction, as depicted by arrow 58 in FIG. 2. Injection of fuel into combustion chamber 62 prior to top dead center allows more time for the fuel and fluid medium (e.g., air and/or exhaust gases recirculated from EGR system 124) to combine into a substantially homogeneous mixture. In contrast, during conventional compression-ignition engine operation, a greater amount of the fuel spray is directed toward the sides of the cylinder, and injection of fuel is timed to occur closer to top dead center of the piston's travel, which allows less time for mixing with the fluid medium prior to combustion.

According to some embodiments, fuel injector 100 may have a “showerhead” configuration as described previously herein with respect to FIGS. 4A and 4B. Fuel injector nozzle 102 may include holes 138 arranged such that fuel spray 134 may be varied to suit particular applications. According to some embodiments, fuel injection may be performed via a port injection arrangement in which the fuel is injected, for example, into intake conduit 78, which may provide for a homogeneous mixing of fuel and the fluid medium (i.e., air and/or recirculated exhaust gases).

According to some exemplary embodiments, the timing of fuel injection may be varied to alter (e.g., improve) performance during HCCI operation. For example, the injection of fuel into combustion chamber 62 may be timed to occur when piston 54's upward travel ranges from about 30 degrees before top dead center to about 180 degrees before top dead center. Such timing may result in a nearly complete homogeneous mixing of the fuel and fluid medium. It may be desirable to inject fuel into combustion chamber 62 later than between about 30 degrees and 180 degrees before top dead center, because fuel may impinge on cylinder wall 40 due to the relatively longer time that the fuel is exposed to cylinder 38, which, in turn, may result in contamination and/or degradation of internal combustion engine 14's oil.

According to exemplary embodiments including a 24-hole “showerhead” fuel injector 100 and no EGR system for recirculating exhaust gases, a preferable injection timing of about 70 degrees before top dead center may be selected, which may result in reduced levels of NOₓ and smoke, along with moderate levels of HC and CO emissions. According to exemplary embodiments including an EGR system for recirculating exhaust gas, a preferable injection timing ranging from about 30 degrees to about 60 degrees before top dead center may be selected, which may substantially prevent fuel from impinging on cylinder wall 40 to an even greater extent than selecting an injection timing of earlier than about 60 degrees before top dead center. According to some exemplary embodiments, alterations to operating conditions, such as, for example, injector nozzle geometry, fuel dispersion patterns, EGR quantity, air intake, and the like, may permit fuel injection to be timed to occur from about 30 degrees before top dead center to about 90 degrees before top dead center.

According to some exemplary embodiments of internal combustion engine 14, it may be desirable to lower the combustion temperature, limit the peak combustion pressure, and/or extend duration of combustion. Lowering the combustion temperature may result in reducing the level of NOₓ emissions. Limiting peak combustion pressure may result in reducing stress on internal combustion engine 14's components, particularly cylinder head 42. Extending the duration of combustion may contribute to reducing the peak combustion pressure.

According to some exemplary embodiments, the combustion temperature may be lowered, the peak combustion pressure may be limited, and/or the duration of combustion may be extended by introducing a large amount of excess mass into combustion chamber 62. Excess mass may be in the form of an increased amount of fluid medium, which may include, for example, air, recirculated exhaust gases (EGR), water, inert gas, and/or any other fluid medium known to a person having ordinary skill in the art. Using air (i.e., ambient air) as the excess mass fluid medium may require delivering a relatively large amount of air to combustion chamber 62 to achieve desired excess mass levels.

According to some exemplary embodiments, a fluid medium other than air (or in addition to air) may be used to achieve excess mass. For example, EGR may be used (or added to air), which may permit operation of internal combustion engine 14 at or near stoichiometric equivalence ratio (i.e., an air-fuel ratio of about 14.5 to 1).

According to some exemplary embodiments, EGR may be used to control heat release rate and/or pressure rise rate within combustion chamber 62. For example, EGR may extend combustion duration and/or reduce peak pressure. For example, addition of EGR may permit brake mean effective pressure (BMEP) levels approaching about 1,600 kPa.

According to some exemplary embodiments, fluid(s) other than (or in addition to) EGR may be added. For example, diluents, such as water, carbon dioxide, nitrogen, and/or any other diluents known to a person having ordinary skill in the art may be added. Such diluents may serve to lower combustion temperature, limit peak combustion pressure, and/or extend the duration of combustion. Diluent(s) affect combustion by lowering the heat release rate in combustion chamber 62 and/or creating a number of interim chemical reactions during combustion, which may serve to extend the combustion event. The mass of the diluent(s) contributes to the total fluid mass in combustion chamber 62, with another portion of fluid mass being the oxidant (e.g., air) introduced to support combustion.

In some exemplary embodiments, the amount of EGR added is preferably quantified as a volumetric percentage, as exemplified by the following equation:

$$\% EGR = \frac{{CO}_{2} ( in )}{{CO}_{2} ( ex )} \times 100 \qquad ( Eq . 1 )$$

where CO₂ (in) is an amount of carbon dioxide being returned to intake system 64 by way of EGR system 124, and CO₂ (ex) is an amount of carbon dioxide exhausted from internal combustion engine 14. The amount of EGR may be a relatively significant percentage, for example, ranging from about 40% to about 60% (i.e., under certain operating conditions). It is noted that the percentage of EGR may be quantified in some other manner such as, for example, by dividing the mass of the EGR by the total mass in combustion chamber 62.

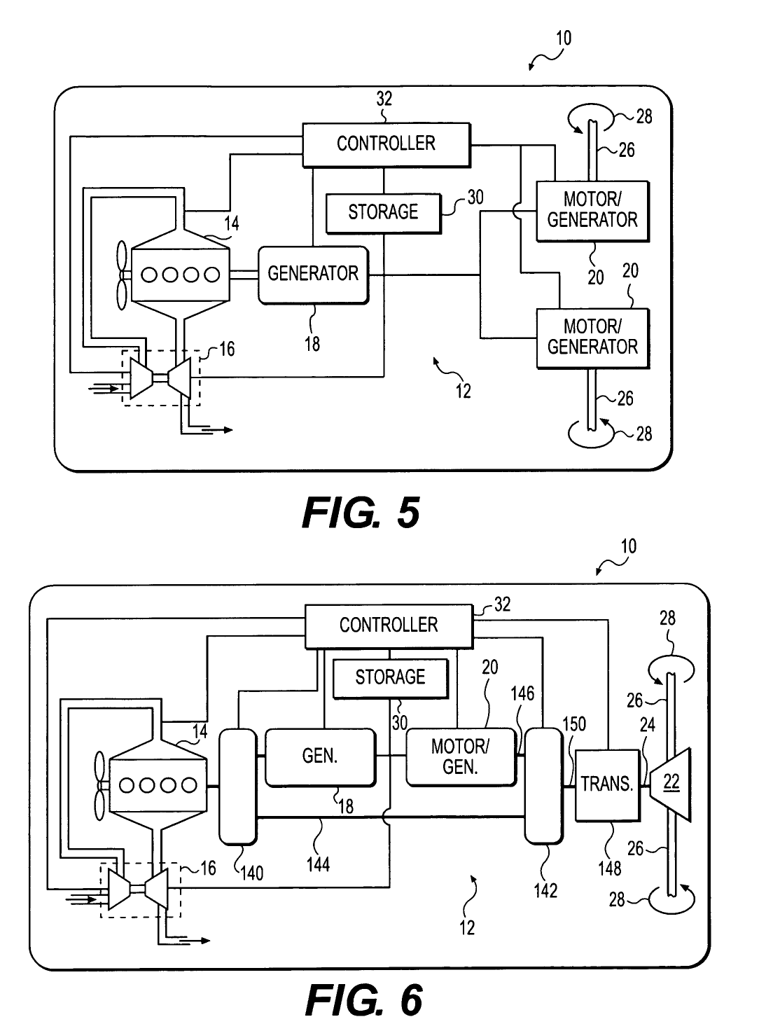

According to some exemplary embodiments, for example, the exemplary embodiment of vehicle 10 schematically-depicted in FIG. 5, vehicle 10 includes a powertrain 12 having a motor/generator 20 operably associated with each propulsion member 28 via an output member 26 rather than a single motor/generator operably associated with a differential (see, e.g., FIG. 1). For example, as shown in FIG. 5, vehicle 10 includes two propulsion members 28 and two motor/generators 20. Each one of motor/generators 20 is operably coupled with one of propulsion members 28 via output member 26. Each output member 26 is configured to transfer torque between each of motor/generators 20 to associated propulsion member 28. Controller 32 is configured to provide control signals to each motor/generator 20 such that vehicle 10 is propelled via propulsion members 28 in response to operator commands.

Although the exemplary embodiment depicted in FIG. 5 shows two propulsion members 28, vehicle 10 may include more than two propulsion members along with a corresponding number of motor/generators. Controller 32 may be configured to send control signals to each of the motor/generators such that the vehicle is propelled via the propulsion members in response to operator commands. Further, the operator may occupy the vehicle while making the commands, the operator may provide commands remote from the vehicle, and/or operation of vehicle 10 may be pre-programmed.

According to some exemplary embodiments, for example, the exemplary embodiment of vehicle 10 schematically-depicted in FIG. 6, powertrain 12 may be configured such that propulsion members 28 receive torque from internal combustion engine 14 and/or motor/generator 20 via output members 26 rather than solely from motor/generator 20 (see, e.g., FIGS. 1 and 5). For example, internal combustion engine 14 is operably coupled to a torque splitter 140. Torque splitter 140 is configured to selectively split torque provided by internal combustion engine 14, such that torque may be supplied to generator 18 and/or to a torque combiner 142. In particular, torque splitter 140 may operate such that a percentage of the torque supplied by internal combustion engine 14 ranging from zero to 100% may be provided to generator 18, with the remaining torque being supplied torque combiner 142 via input member 144. Torque combiner 142 is configured to combine torque provided by motor/generator 20 via mechanical link 146 and torque provided by internal combustion engine 14 via input member 144. Torque combiner 142 is operably coupled to a transmission 148 via an output shaft 150, which, in turn, is operably coupled to a differential 22 via a drive member 24. Transmission 148 may be any transmission known to a person having ordinary skill in the art, such as, for example, a continuously-variable transmission, a powershift transmission, a hydrostatic transmission, an automatic transmission, and a manual transmission. Differential 22 is configured to drive output members 26, which provide power to propulsion members 28. According to some embodiments, generator 18 and motor/generator 20 may be combined in a single unit, for example, in the interest of more compact component packaging.

By virtue of the exemplary configuration shown on FIG. 6, internal combustion engine 14 and motor/generator 20 may supplement one another to provide power to transmission 148. For example, internal combustion engine 14 may supplement motor/generator 20, for example, if controller 32 determines that operation of vehicle 10 would benefit from torque being supplied by internal combustion engine 14 (e.g., if more torque than the torque being supplied by motor/generator 20 is needed to propel vehicle 10 in response to the operator's commands). Similarly, motor/generator 20 may supplement internal combustion engine 14, for example, if controller 32 determines that operation of vehicle 10 would benefit by torque being supplied by motor/generator 20 (e.g., if more torque than the torque being supplied by internal combustion engine 14 is needed to propel vehicle 10 in response to the operator's commands).

### INDUSTRIAL APPLICABILITY

The exemplary powertrains and methods of operating a powertrain may be applicable to any type of vehicle, for example, an automobile, a truck, a rail vehicle such as a train or a subway train, or a construction vehicle (e.g., such as a track-type tractor, a wheel loader, a hydraulic excavator, motor grader, or the like). Further, the exemplary powertrains and methods of operating a powertrain may be applicable to water-borne vehicles, such as boats or ships, or airplanes. In particular, exemplary powertrains and methods of operating a powertrain may be applicable to hybrid powertrains, which include a homogeneous-charge compression ignition (HCCI) engine.

For example, as depicted in FIG. 1, powertrain 12 includes an internal combustion engine 14, which converts fuel into mechanical power. Internal combustion engine 14 includes an air compression device 16, for example, one or more turbochargers (see, e.g., FIG. 3). Internal combustion engine 14 supplies mechanical power to generator 18, which, in turn, converts the mechanical power into electric power or hydraulic power. Generator 18 supplies electric or hydraulic power to motor/generator 20, which converts electric or hydraulic power into mechanical power. Motor/generator 20 drives differential 22 via drive member 24. Differential 22 drives one or more output members 26, which, in turn, drive a corresponding number of propulsion members 28, which serve to propel vehicle 10. Propulsion members 28 may be, for example, drive wheels, tracks (i.e., tracks of a track-driven vehicle), and/or propellers (i.e., for a boat or an airplane).

One or more energy storage devices 30 are coupled to generator 18, motor/generator 20, and/or internal combustion engine 14 (e.g., at sir compression device 16), such that energy (i.e., electric energy) may be stored for later use by powertrain 12 and/or other systems of vehicle 10. Energy storage device(s) 30 may include any batteries and/or capacitors (i.e., for storing electric energy, and/or an accumulator (i.e., for storing hydraulic energy). Powertrain 12 may include a controller 32 configured to coordinate the operation the various components of powertrain 12.

Internal combustion engine 14 may operate as a homogeneous-charge compression ignition (HCCI) engine, and powertrain 12 is configured to permit internal combustion engine 14 to be an HCCI engine while still being suitable for vehicle use. Powertrain 12 may be configured to operate internal combustion engine 14 at a relatively constant load and/or engine speed, for example, a load and/or engine speed that generally optimizes efficiency and/or emissions of internal combustion engine 14. For example, powertrain 12 may operate internal combustion engine 14 at, for example, at least about 25% of full load and between about idle and about 2,000 rpm (e.g., about 25-50% of full load and about 1,200 rpm). Propulsion and/or operation of vehicle 10's systems may be powered by electric power generated by generator 18, which is driven by internal combustion engine 14. For example, motor/generator 20 receives electric or hydraulic power from generator 18 and, in turn, supplies mechanical power to propulsion members 28 according to an operator's commands. If internal combustion engine 14 is providing more mechanical power to generator 18 than required to meet an operator's commands, excess power generated by generator 18 may be stored in energy storage device 30.

If energy storage device 30 has reached its full capacity of stored energy, generation of electric or hydraulic power via generator 18 may be reduced or ceased, for example, by reducing the speed and/or load of generator 18 or ceasing operation of generator 18. This may be accomplished by, for example, reducing the speed and/or load of internal combustion engine 14, stopping operation of internal combustion engine 14, and/or disconnecting internal combustion engine 14 from generator 18 (e.g., via a clutch). Such operation of powertrain 12 may be coordinated via controller 32.

If, on the other hand, more power is required than can be supplied by internal combustion engine 14 and generator 18 to propel vehicle 10 according to an operator's commands (e.g., due either to vehicle 10 traveling up a hill or an operator's desire to increase vehicle speed), motor/generator 20 may receive additional electric power from energy storage device 30, such that vehicle 10 operates according to the operator's commands. Such operation of powertrain 12 may be coordinated via controller 32.

According to some embodiments, powertrain 12 is configured to operate internal combustion engine 14 at a relatively constant load and/or speed under generally consistent operating conditions, and to increase output (i.e., power and/or engine speed) under operating circumstances that call for higher output. For example, as vehicle 10 travels at a relatively constant speed on relatively level terrain, internal combustion engine 14 may operate at about 25%-50% of full load and at about 1,200 rpm. If vehicle 10 requires an increase in power, for example, due to travel uphill, and/or operation of vehicle systems that draw more power, operation of internal combustion engine 14 may be altered to increase its power output and/or engine speed. If an increase in power occurs relatively suddenly, internal combustion engine 14 (i.e., an HCCI engine) may not be able to respond in a sufficiently timely manner to the sudden need for more power (e.g., without undue emissions implications).

According to some embodiments, powertrain 12 may operate such that electric or hydraulic energy stored in energy storage device 30 substantially compensates for any delayed response to sudden power demands while internal combustion engine 14 increases power and/or engine speed to meet the demand for increased power (e.g., without necessarily increasing emissions). For example, energy storage device supplies electric or hydraulic power to motor/generator 20, such that motor/generator 20 supplies sufficient power to propulsion members 28 in order to compensate for any insufficiency of power provided by internal combustion engine 14, until internal combustion engine 14 responds to the need for more power by increasing power output and/or engine speed.

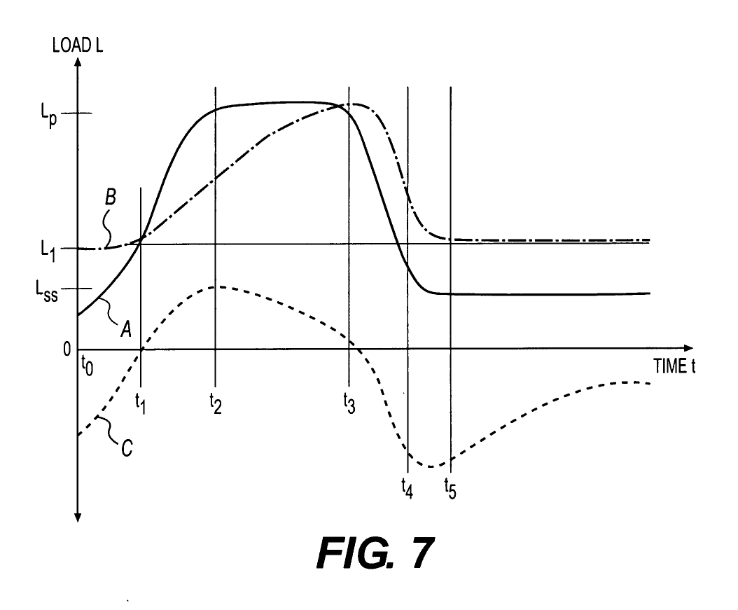

For example, as depicted in FIG. 7, powertrain 12 may be configured to operate internal combustion engine 14 at L₁ under normal operating conditions. As power requirements fluctuate based on operator commands and/or changes in terrain, resulting relatively minor changes in power output requirements are met by a combination of adjusting power output of internal combustion engine 14 and/or motor/generator 20. In particular, relatively minor changes in required power and/or relatively slowly occurring fluctuations in required power may be accommodated by varying the power output of internal combustion engine 14.

If, on the other hand, changes in required power are abrupt or drastic, internal combustion engine 14 may not be able to respond as quickly as the changing requirements, for example, if internal combustion engine 14 is an HCCI engine. In such case, powertrain 12 compensates for internal combustion engine 14's inability to respond in a sufficiently timely manner.

As depicted in exemplary FIG. 7, curve A represents a power demand curve in relation to time. At t₀, the power demand curve rises sharply from a steady state power requirement Lₛₛ to a peak power requirement Lₚ at t₂. A drastic increase in required power might occur, for example, as a vehicle encounters a hill. In order to maintain a constant vehicle speed, more power is required as the vehicle travels up the hill.

As the vehicle crests the hill and begins to travel down the other side of the hill, for example, a relatively abrupt drop in required power may occur. Referring to power demand curve A, a drastic decrease in demanded power is depicted between t₃ and t₄, where power demand drops from Lₚ to Lₛₛ. Once the vehicle begins traveling on relatively level terrain, the power demanded remains relatively consistent at Lₛₛ.

Curve B shown in FIG. 7 depicts the power output of exemplary internal combustion engine 14. As depicted, internal combustion engine 14 does not respond immediately to the power demanded as shown by power demand curve A. Rather, power output curve B lags behind power demand curve A. In particular, power output curve B remains substantially constant at L₁ until power demand curve A exceeds L₁ a t₁. Thereafter, power output curve B increases, but not as quickly as power demand curve A, such that a power deficit occurs, as represented by the difference between power demand curve A and power output curve B. Between t₂ and t₃, however, power output curve B continues to increase to match power demand curve A at Lₚ. As power demand curve A drops drastically back to Lₛₛ between t₃ and t₄, power output curve B may remain higher than the demanded power for a relatively short period of time, since it fails to drop as quickly as the power demand curve A. Power output curve B eventually returns to L₁ at t₅.

As shown in FIG. 7, the power output curve B generally lags behind the power demand curve A, such that as power demand rises abruptly, power output curve B illustrates that internal combustion engine 14 (e.g., an HCCI engine) fails to respond quickly enough to maintain sufficient power to meet the increased demand. Further, as power demand decreases abruptly, power output curve B illustrates that internal combustion engine 14 provides more power than demanded for a relatively short period of time. If left uncompensated, such a lag in response of internal combustion engine 14 might render it unsuitable for use in vehicle 10.

Exemplary powertrain 12 compensates for the lag in internal combustion engine 14's response by supplying and storing energy via energy storage device 30. As depicted in FIG. 7, for example, internal combustion engine 14 between t₀ and t₁ operates such that it produces excess power, as shown by the difference between power output curve B and power demand curve A. The excess power is stored in energy storage device 30 as depicted by energy storage/supply curve C (i.e., energy stored is represented by negative values on energy storage/supply curve C, and energy supplied is represented by positive values on energy storage/supply curve C). The slope of energy storage/supply curve C is positive, denoting a reduction in the rate of energy storage as time approaches t₁.

Beginning at t₁, internal combustion engine 14 supplies less power than demanded until t₃, as shown by power demand curve A exceeding power output curve B. As shown by energy storage/supply curve C, energy storage device 30 supplies power to motor/generator 20 between t₁ and t₃ in order to provide sufficient power to meet the increased demand until internal combustion engine 14 has responded sufficiently to meet the demand at t₃, as depicted by energy storage/supply curve C dropping below zero. Once internal combustion engine 14 begins to provide sufficient power at t₃ to meet vehicle 10's increased power demands, energy storage/supply curve C approaches zero.

As vehicle 10 crests the hill and begins to travel down the other side, the power demanded drops faster than internal combustion engine 14 can respond, as illustrated by the power demand curve A dropping faster than power output curve B beginning at t₃. This indicates that internal combustion engine 14 is outputting excess power. As indicated by energy storage/supply curve C, energy storage device 30 stores the excess power beginning at t₃. Once internal combustion engine 14 fully responds to the decreased demand at t₆, the power output of internal combustion engine 14 returns the steady state level at L₁, as indicated by power output curve B, which returns to L₁ at t₅. Energy storage returns to the steady state at t₅.

According to some embodiments, if, for example, energy storage device 30 can accept no more energy for storage, powertrain 12 may discontinue energy storage. For example, powertrain 12 may discontinue operation of internal combustion engine 14 and/or disconnect internal combustion engine 14's output from generator 20 (e.g., via a clutch). According to some embodiments, powertrain 12 may include an energy dissipation device configured to dissipate any excess power supplied by internal combustion engine 14.

In this exemplary manner, powertrain 12 is able to compensate for internal combustion engine 14's delayed response to power demands placed on powertrain 12, for example, when internal combustion engine 14 is an HCCI engine.

It will be apparent to those skilled in the art that various modifications and variations can be made to the exemplary embodiments disclosed. Other embodiments will be apparent to those skilled in the art from consideration of the specification and practice of the disclosed embodiments. It is intended that the specification and examples be considered as exemplary only, with a true scope being indicated by the following claims and their equivalents.

What is claimed is:

1. A powertrain comprising:
an HCCI engine configured to supply mechanical power;
a generator operably coupled to the HCCI engine, the generator being configured to convert at least a portion of the mechanical power into one of electric energy and hydraulic energy;
a motor operably coupled to the generator, the motor being configured to supply torque to a propulsion member;
an energy storage device operably coupled to the generator and the motor, the energy storage device being configured to store one of electric energy and hydraulic energy; and
a controller operably coupled to the HCCI engine, the generator, the motor, and the energy storage device,
wherein the controller is configured to control the powertrain such that energy stored in the energy storage device is supplied to the motor when the HCCI engine supplies insufficient mechanical power to the generator to supply the motor with sufficient power to meet power requirements of the powertrain, until the HCCI engine supplies sufficient mechanical power to the generator to supply the motor with sufficient power to meet the power requirements of the powertrain.

2. The powertrain of claim 1, wherein the controller is configured to control the powertrain such that when the HCCI engine supplies more mechanical power to the generator than an amount of power required for the motor to meet the power requirements of the powertrain, excess mechanical power is converted by the generator into one of electric energy and hydraulic energy, which is stored in the energy storage device.

3. The powertrain of claim 1, wherein the controller is configured to operate the HCCI engine within a predetermined range of power outputs.

4. The powertrain of claim 3, wherein the predetermined range of power outputs ranges from about 25% to about 100% of a maximum power output of the HCCI engine.

5. The powertrain of claim 4, wherein the predetermined range of power outputs ranges from about 25% to about 50% of the maximum power output of the HCCI engine.

6. The powertrain of claim 1, wherein the controller is configured to control operation of the powertrain such that the mechanical power is no longer supplied to the generator when the energy storage device has reached maximum capacity.

7. The powertrain of claim 6, wherein the HCCI engine is disconnected from the generator when the energy storage device has reached maximum capacity.

8. The powertrain of claim 6, wherein the HCCI engine is shut off when the energy storage device has reached maximum capacity.

9. The powertrain of claim 1, including a propulsion member, wherein the propulsion member is selected from wheels, tracks, and propellers.

10. The powertrain of claim 1, including two motors and two propulsion members, wherein one of the two motors is operably coupled to one of the two propulsion members, and another of the two motors is operably coupled to another of the two propulsion members.

11. The powertrain of claim 1, including a transmission configured to supply torque to the propulsion member, wherein the motor and the HCCI engine are operably coupled to the transmission.

12. The powertrain of claim 1, wherein the HCCI engine includes a turbocharger, wherein the turbocharger includes a turbine operably coupled to a second generator configured to convert mechanical power from the turbine into electric power for storage in the energy storage device.

13. The powertrain of claim 1, wherein the motor includes a second generator configured to convert mechanical power from the propulsion member into one of electric energy and hydraulic energy for storage in the energy storage device.

14. The powertrain of claim 1, wherein the generator includes an electric generator, the motor includes an electric motor, and the energy storage device includes at least one of a battery and a capacitor.

15. The powertrain of claim 1, wherein the generator includes at least one of a variable displacement pump and a fixed displacement pump, the motor includes a hydraulic motor, and the energy storage device includes an accumulator.

16. A vehicle comprising:
a powertrain including
an HCCI engine configured to supply mechanical power,
a generator operably coupled to the HCCI engine, the generator being configured to convert at least a portion of the mechanical power into one of electric energy and hydraulic energy,
a motor operably coupled to the generator, the motor being configured to supply torque to a propulsion member,
an energy storage device operably coupled to the generator and the motor, the energy storage device being configured to store one of electric energy and hydraulic energy;
a controller operably coupled to the HCCI engine, the generator, the motor, and the energy storage device, and
a propulsion member configured to propel the vehicle,
wherein the controller is configured to control the powertrain such that energy stored in the energy storage device is supplied to the motor when the HCCI engine supplies insufficient mechanical power to the generator to supply the motor with sufficient power to meet power requirements of the powertrain, until the HCCI engine supplies sufficient mechanical power to the generator to supply the motor with sufficient power to meet the power requirements of the powertrain.

17. The vehicle of claim 16, wherein the controller is configured to control the powertrain such that when the HCCI engine supplies more mechanical power to the generator than an amount of power required for the motor to meet the power requirements of the powertrain, excess mechanical power is converted by the generator into one of electric energy and hydraulic energy, which is stored in the energy storage device.

18. The vehicle of claim 16, wherein the controller is configured to operate the HCCI engine within a predetermined range of power outputs.

19. The vehicle of claim 18, wherein the predetermined range of power outputs ranges from about 25% to about 100% of a maximum power output of the HCCI engine.

20. The vehicle of claim 19, wherein the predetermined range of power outputs ranges from about 25% to about 50% of the maximum power output of the HCCI engine.

21. The vehicle of claim 16, wherein the controller is configured to control operation of the powertrain such that the mechanical power is no longer supplied to the generator when the energy storage device has reached maximum capacity.

22. The vehicle of claim 21, wherein the HCCI engine is disconnected from the generator when the energy storage device has reached maximum capacity.

23. The vehicle of claim 21, wherein the HCCI engine is shut off when the energy storage device has reached maximum capacity.

24. The vehicle of claim 16, wherein the propulsion member is selected from wheels, tracks, and propellers.

25. The vehicle of claim 16, including two motors and two propulsion members, wherein one of the two motors is operably coupled to one of the two propulsion members, and another of the two motors is operably coupled to another of the two propulsion members.

26. The vehicle of claim 16, including a transmission configured to supply torque to the propulsion member, wherein the motor and the HCCI engine are operably coupled to the transmission.

27. The vehicle of claim 16, wherein the HCCI engine includes a turbocharger, wherein the turbocharger includes a turbine operably coupled to a second generator configured to convert mechanical power from the turbine into electric power for storage in the energy storage device.

28. The vehicle of claim 16, wherein the motor includes a second generator configured to convert mechanical power from the propulsion member into one of electric energy and hydraulic energy for storage in the energy storage device.

29. The vehicle of claim 16, wherein the vehicle is selected from automobiles, trucks, trains, subway trains, boats, ships, and airplanes.

30. The vehicle of claim 16, wherein the generator includes an electric generator, the motor includes an electric motor, and the energy storage device includes at least one of a battery and a capacitor.

31. The vehicle of claim 16 wherein the generator includes at least one of a variable displacement pump and a fixed displacement pump, the motor includes a hydraulic motor, and the energy storage device includes an accumulator.

32. A method for operating a powertrain including an HCCI engine, the method comprising:
generating mechanical power via operation of the HCCI engine;
converting at least a portion of the mechanical power into one of electric energy and hydraulic energy;
supplying the energy to a motor and an energy storage device;
driving a propulsion member via the motor; and
controlling the powertrain such that energy stored in the energy storage device is supplied to the motor when the HCCI engine generates insufficient mechanical power to supply the motor with sufficient power to meet power requirements of the powertrain, until the HCCI engine supplies sufficient mechanical power to supply the motor with sufficient power to meet the power requirements of the powertrain.

33. The method of claim 32, including controlling the powertrain such that when the HCCI engine generates more mechanical power than an amount of power required for the motor to meet the power requirements of the powertrain, excess mechanical power is converted into one of electric energy and hydraulic energy and stored in the energy storage device.
